(19) United States
(12) Patent Application Publication
(10) Pub. No.: US 2017/0165140 A1
(43) Pub. Date: Jun. 15, 2017

(54) DISPOSABLE BEDPAN

(71) Applicant: Sircare, LLC., Aventura, FL (US)

(72) Inventor: Gustavo Guillermo PINUS, Buenos Aires (AR)

(73) Assignee: Sircare, LLC., Aventura, FL (US)

(21) Appl. No.: 14/965,119

(22) Filed: Dec. 10, 2015

(51) Int. Cl. A61G 9/00

(52) U.S. Cl. CPC A61G 9/003

(57) ABSTRACT

A disposable bedpan having a bedpan with a base and a sidewall. The sidewall has at least one lateral support. A cover has a cover base. The cover mounts upon the bedpan when assembled to support a user thereon. The bedpan collects human waste. The bedpan and the cover are for a single use, thus disposable. A plurality of the bedpan is stackable upon one another, and a plurality of the cover is stackable upon one another to be volumetrically efficient for carrying, transporting, and/or storage.

### BACKGROUND OF THE INVENTION

1. Field of the Invention

The present invention relates to bedpans, and more particularly, to disposable bedpans.

2. Description of the Related Art

Applicant believes that one of the closest references corresponds to U.S. Pat. No. 6,351,858 issued to Mario Fernando Toia on Mar. 5, 2002 for a Disposable Container for Collecting Human Wastes and a Container-Grinding Machine. However, it differs from the present invention because Toia teaches a process for disposing of human waste in an efficient and environmentally or pathologically safe manner, a grindable container for collecting human waste and a crushing machine for said containers. The container is made of a grindable, biodegradable material such as cellulose pulp and is designed to hold human waste without any leaks or cracks. The container is formed by an upper portion and a lower portion, both comprising corresponding snap-in peripheral engaging flanges for engaging one to the other without the use of gluing products and comprising an anti-slipping surface finish for avoiding slippage of the container during usage and designed for comfortable human skin contact. The crushing machine is designed to be used at any health-care or rest-home center and is adequate for dumping the final product into a sewer system in an environmental caring manner.

Other patents describing the closest subject matter provide for a number of more or less complicated features that fail to solve the problem in an efficient and economical way. None of these patents suggest the novel features of the present invention.

### SUMMARY OF THE INVENTION

The instant invention is a disposable bedpan, comprising a bedpan having a base and a sidewall with at least one lateral support, and a cover comprising a cover base. The cover mounts upon the bedpan when assembled to support a user thereon. The bedpan collects human waste. The bedpan and the cover are for a single use, thus disposable. A plurality of the bedpan is stackable upon one another, and a plurality of the cover is stackable upon one another.

The bedpan further comprises a top ridge and a front ridge. A front top cavity defined between the top ridge and the front ridge. The base comprises at least one ridge that extends perpendicularly across the base. The at least one lateral support protrudes inwardly from the sidewall. Each of the at least one lateral support is tapered from the base towards the top ridge. The bedpan further comprises a front base support. The bedpan further comprises a front bottom cavity defined between the base and the front base support, a base support.

The cover base comprises at least one cover ridge that extends perpendicularly across the cover base. The cover further comprises a cover front ridge. The cover further comprises a cover front top cavity defined between the cover front ridge and the cover base. The cover further comprises a cover cavity defined by a cover base support, and a cover base ridge.

It is therefore one of the main objects of the present invention to provide a disposable bedpan comprising a bedpan and a cover.

It is another object of this invention to provide a disposable bedpan, whereby the bedpans and covers are stackable.

It is another object of this invention to provide a disposable bedpan that sustains the weight of a user thereon.

It is another object of this invention to provide a disposable bedpan that is volumetrically efficient for carrying, transporting, and storage.

It is another object of this invention to provide a disposable bedpan that can be readily assembled and disassembled without the need of any special tools.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a top isometric view of a disassembled disposable bedpan.

FIG. 2 represents a bottom isometric view of the disassembled disposable bedpan.

FIG. 3 represents a first isometric view of an assembled disposable bedpan.

FIG. 4 represents a second isometric view of the assembled disposable bedpan.

FIG. 5A is a side view of three stacked covers that are volumetrically efficient for carrying, transporting, and/or storage.

FIG. 5B is a side view of three stacked bedpans that are volumetrically efficient for carrying, transporting, and/or storage.

### DETAILED DESCRIPTION OF THE PREFERRED EMBODIMENT

Referring now to the drawings, the present invention is a disposable bedpan and is generally referred to with numeral 10. It can be observed that it basically includes bedpan 20 and cover 120.

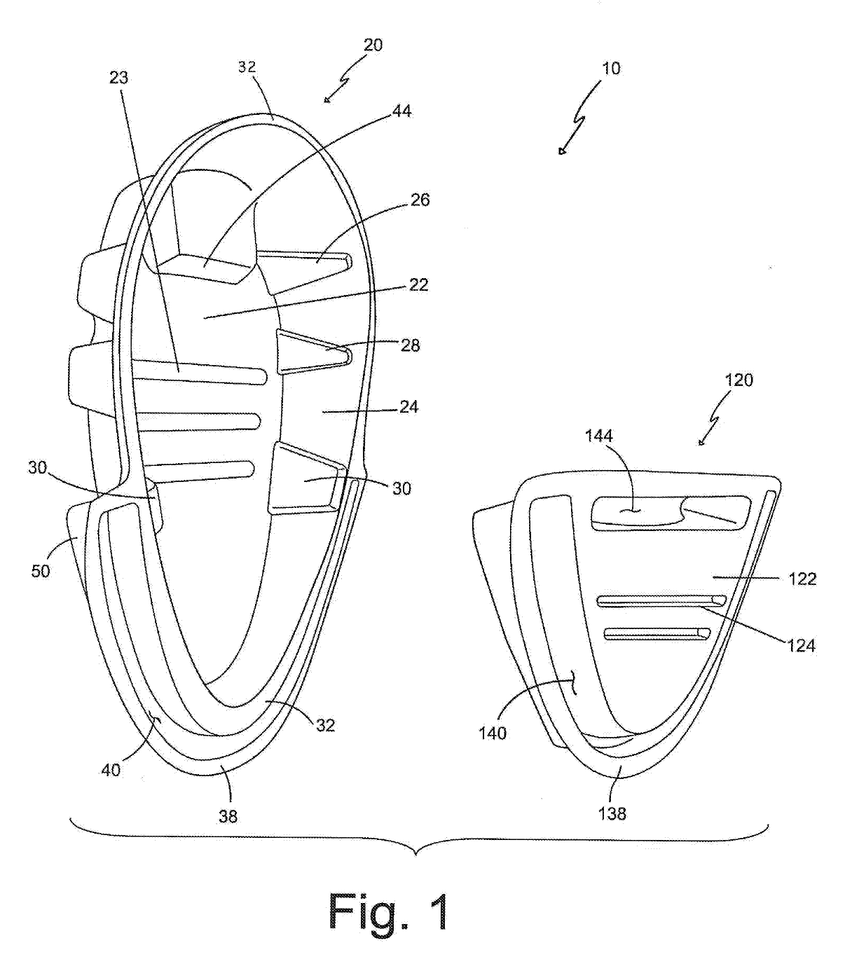

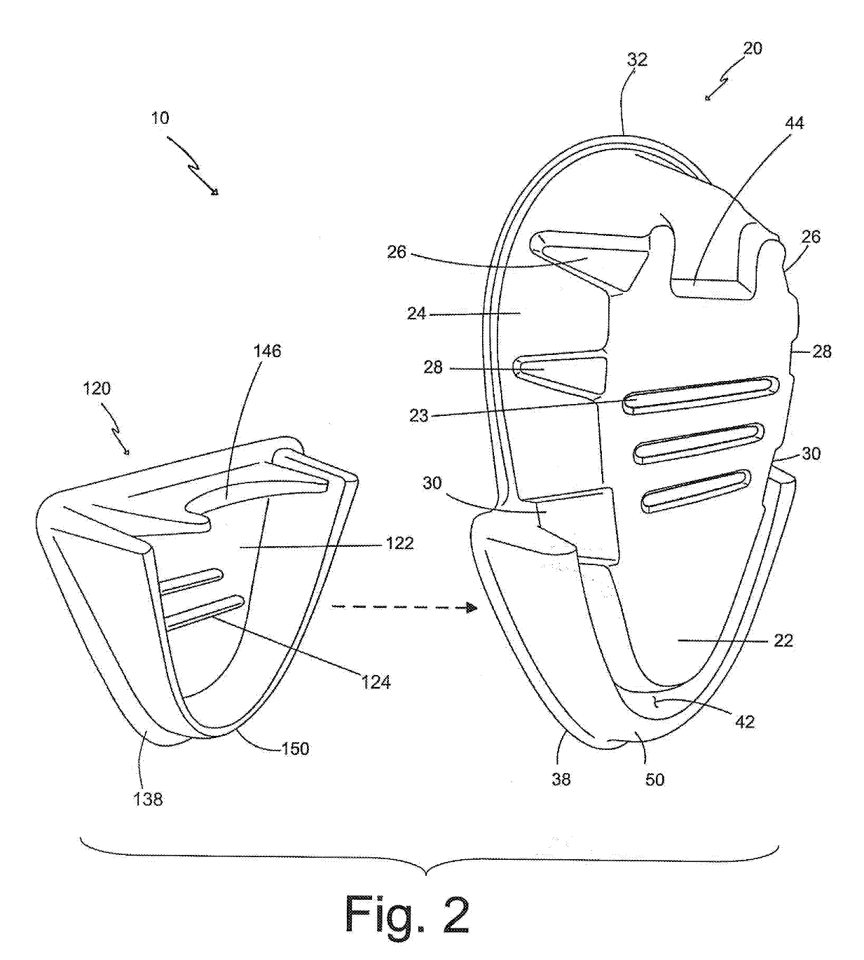

As seen in FIGS. 1 and 2, disposable bedpan 10 comprises bedpan 20 having base 22 and sidewall 24 with at least one lateral support. In a preferred embodiment, bedpan 20 is generally oval in shape. In a preferred embodiment, bedpan 20 is symmetrical, whereby sidewall 24 has a set of each lateral supports 26, 28, and 30 on its longitudinal sides. Bedpan 20 further comprises top ridge 32 and front ridge 38. Each lateral supports 26, 28, and 30 protrude inwardly from sidewall 24, and are tapered from base 22 towards top ridge 32. Base 22 comprises at least one ridge 23. Each ridge 23 extends perpendicularly across base 22. In a preferred embodiment, ridges 23 protrude inwardly from base 22. Front top cavity 40 is defined between top ridge 32 and front ridge 38. Front ridge 38 contours and extends along a perimeter section of top ridge 32. Bedpan 20 further comprises front base support 50. Front bottom cavity 42 is defined between base 22 and front base support 50. Bedpan 20 further comprises base support 44.

Disposable bedpan 10 also comprises cover 120 having cover base 122 with at least one cover ridge 124 that extends perpendicularly across cover base 122. Cover 120 further comprises cover front ridge 138. Cover 120 further comprises cover front top cavity 140 defined between cover front ridge 138 and cover base 122. Cover 120 has cover cavity 144 defined by cover base support 146, and cover base ridge 150. Cover base support 146 forms an arch. In a preferred embodiment, cover 120 is symmetrical.

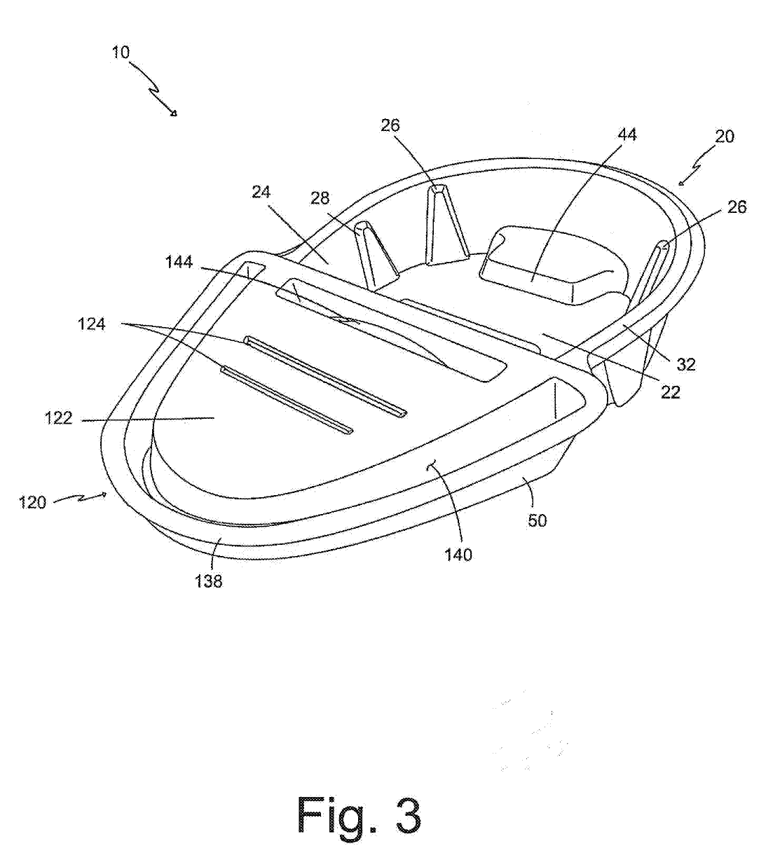

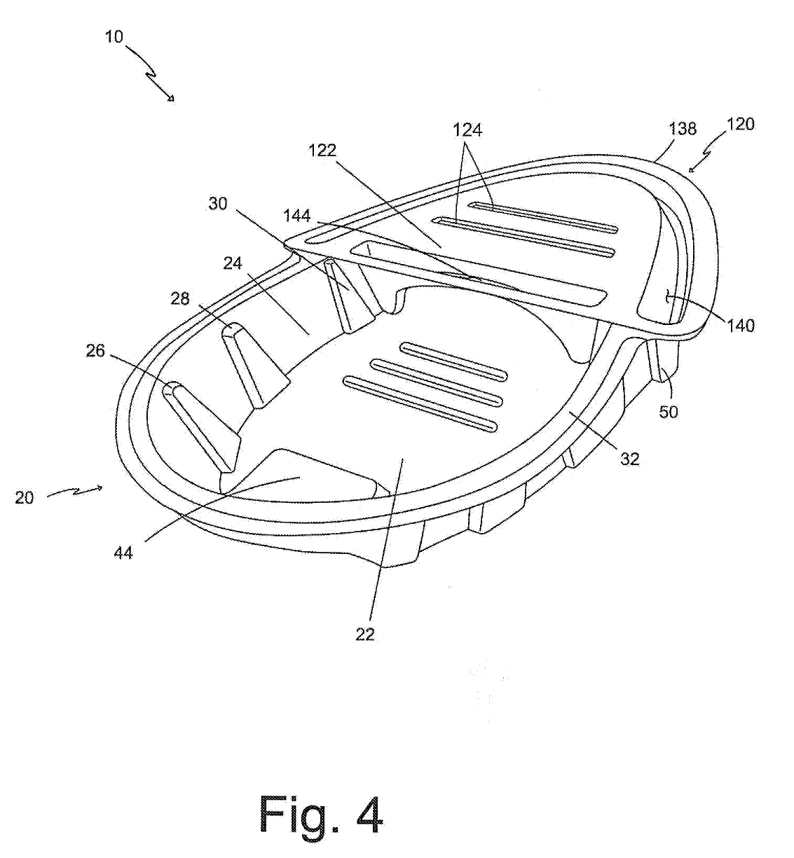

As seen in FIGS. 3 and 4, cover 120 mounts upon bedpan 20 when assembled to support a user thereon, whereby cover base ridge 150 and cover base support 146 rest upon base 22. Bedpan 20 collects human waste including urine and feces or excrement. Disposable bedpan 10 is disposable, intended for a single use and is constructed of biodegradable materials.

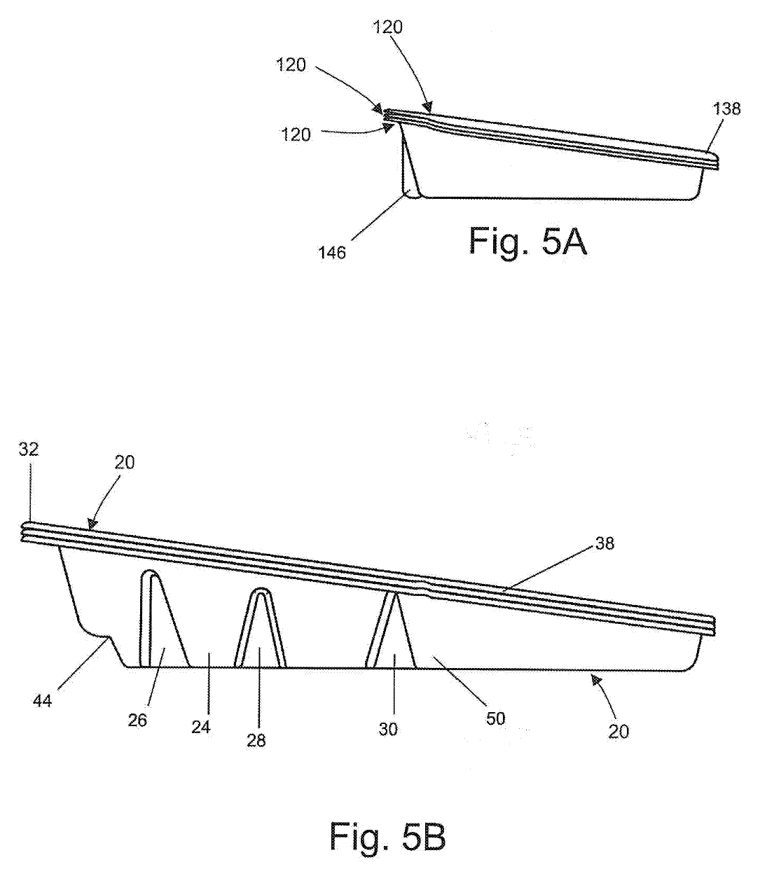

As seen in FIG. 5A, covers 120 are stackable upon one another to be volumetrically efficient for carrying, transporting, and/or storage, whereby a cover front top cavity 140 from a first cover 120 receives a cover base ridge 150 from a second cover 120.

As seen in FIG. 5B, bedpans 20 are stackable upon one another to be volumetrically efficient for carrying, transporting, and/or storage, whereby a front top cavity 40 from a first bedpan 20 receives a front base support 50 from a second bedpan 20.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. A disposable bedpan, comprising:
A) a bedpan comprising a base and a sidewall having at least one lateral support, said bedpan further comprises a top ridge and a front ridge, said bedpan further comprises a front top cavity defined between said top ridge and said front ridge; and
B) a cover comprising a cover base, a cover cavity defined by an arched shaped cover base support, and a u-shaped cover base ridge, said u-shaped cover base ridge is inserted into said front top cavity when said cover mounts upon said bedpan when assembled to support a user thereon, said bedpan collects human waste.

2. The disposable bedpan set forth in claim 1, further characterized in that said bedpan and said cover are for a single use.

3. The disposable bedpan set forth in claim 1, further characterized in that said bedpan and said cover are disposable.

4. The disposable bedpan set forth in claim 1, further characterized in that a plurality of said bedpan are stackable upon one another.

5. The disposable bedpan set forth in claim 1, further characterized in that a plurality of said cover are stackable upon one another.

6. (canceled)

7. (canceled)

8. (canceled)

9. The disposable bedpan set forth in claim 1, further characterized in that said base comprises at least one ridge.

10. The disposable bedpan set forth in claim 9, further characterized in that said at least one ridge extends perpendicularly across said base.

11. The disposable bedpan set forth in claim 1, further characterized in that said at least one lateral support protrudes inwardly from said sidewall.

12. The disposable bedpan set forth in claim 1, further characterized in that each of said at least one lateral support is tapered from said base towards said top ridge.

13. The disposable bedpan set forth in claim 1, further characterized in that said bedpan further comprises a front base support.

14. The disposable bedpan set forth in claim 13, further characterized in that said bedpan further comprises a front bottom cavity defined between said base and said front base support.

15. The disposable bedpan set forth in claim 1, further characterized in that said bedpan further comprises a base support.

16. The disposable bedpan set forth in claim 1, further characterized in that said cover base comprises at least one cover ridge.

17. The disposable bedpan set forth in claim 16, further characterized in that said at least one cover ridge extends perpendicularly across said cover base.

18. The disposable bedpan set forth in claim 1, further characterized in that said cover further comprises a cover front ridge.

19. The disposable bedpan set forth in claim 18, further characterized in that said cover further comprises a cover front top cavity defined between said cover front ridge and said cover base.

20. (canceled)
